(19) United States
(12) Patent Application Publication
(10) Pub. No.: US 2026/0100297 A1
(43) Pub. Date: Apr. 9, 2026

(54) MOISTURE SHEDDING ELECTRICAL INSULATORS FOR USE IN POWER TRANSMISSION AND DISTRIBUTION LINES

(71) Applicant: Rajkumar PADMAWAR, Victoria (CA)

(72) Inventor: Rajkumar PADMAWAR, Victoria (CA)

(21) Appl. No.: 19/112,202

(22) PCT Filed: Feb. 7, 2023
(86) PCT No.: PCT/CA2023/050160

§ 371 Date: Mar. 14, 2025

(30) Foreign Application Priority Data
Sep. 22, 2022 (CA) 3176424

(51) Int. Cl. H01B 17/56; H01B 17/02

(52) U.S. Cl. CPC H01B 17/56; H01B 17/02

(57) ABSTRACT

A composite insulator is provided for use in power distribution and transmission, the composite insulator comprising: a rod which includes a core rod and a housing which sheaths the core rod; and a plurality of sheds wherein at least one shed has a smaller diameter and at least one shed has a larger diameter and is disposed above the shed with the smaller diameter, the shed with the larger diameter including a downward extending perimeter lip.

### FIELD

The present technology is a robust insulator, suitable for use in coastal and shoreline areas. More specifically, it is a composite insulator that has at least one shed with a lip to both shield and shed moisture, thereby reducing adhesion of pollution and algae.

### BACKGROUND

Distribution and transmission line insulators, post insulators, suspension insulators, bushings and fuse cutouts all must withstand exposure to harsh environmental conditions, including temperature extremes, icing, snow load, high humidity, salt spray from roads and rain. Coastal and shoreline areas and areas with pollution offer one of the more challenging environments as one or more of humidity, seawater spray, lake water spray and rain encourages algae adhesion due moisture ingress into polymer and composite insulator. This adhesion in turn rapidly degrades the polymer surface of these electrical insulators.

United States Patent Application Publication No. 20180106850 discloses a composite insulator (1) for overhead power lines that comprises a rigid core extending axially between two attachment fittings (6) and having placed thereon a shell having sheds (5, 5′) made of electrically insulating synthetic material. It includes a detector device for detecting surface leakage currents, which device includes an electrically conductive metal annular ring (7) surrounding the shell between an end shed (5′) adjacent to one of the two fittings (6) and another shed (5) adjacent to the end shed (5′) that extends radially over the ring (7). The ring (7) is connected by a conductive wire (8) passing through the end shed (5′) to be connected to an electronic unit (9) of the detector device. This does not address the issue of water and water damage.

United States Patent Application Publication No. 20180106846 discloses an overhead power line insulator that comprises a dielectric element (4) having an outside surface forming a skirt (5) with a head extended by a metal attachment fitting (7) for attaching the insulator, and a device for detecting surface leakage current flowing on the dielectric (4), the device comprising a conductive ring (8) that surrounds the fitting (7) and that is in contact with the outside surface of the dielectric (4). An electrically insulating protective element (10) is provided in the form of a collared bushing that surrounds the fitting (7), being interposed between the ring (8) and the fitting (7) and extending radially so as to overlie the ring (8) in order to protect it from environmental pollution. This does not address the issue of water and water damage.

United States Patent Application Publication No. 20060081394 discloses a method of applying Lotus Effect materials as a (super hydrophobicity) protective coating for external electrical insulation system applications, as well as the method of fabricating/preparing Lotus Effect coatings. Selected inorganic or polymeric materials are applied on the insulating material surface, and stable superhydrophobic coatings can be fabricated. Various UV stabilizers and UV absorbers can be incorporated into the coating system to enhance the coating's UV stability. This is more specifically for the power line, but does promote shedding of water from the surface, while taking dirt and debris with the water.

United States Patent Application Publication No. 20050034892 discloses a composite insulator containing means for providing early warning of impending failure due to stress corrosion cracking, flash under, or destruction of the rod by discharge activity conditions is described. A composite insulator comprising a fiberglass rod surrounded by a polymer housing and fitted with metal end fittings on either end of the rod is doped with a dye-based chemical dopant. The dopant is located around the vicinity of the outer surface of the fiberglass rod. The dopant is formulated to possess migration and diffusion characteristics correlating to those of water, and to be inert in dry conditions and compatible with the insulator components. The dopant is placed within the insulator such that upon the penetration of moisture through the housing to the rod through a permeation pathway in the outer surface of the insulator, the dopant will become activated and will leach out of the same permeation pathway. The activated dopant then creates a deposit or stain on the outer surface of the insulator housing. The dopant comprises a dye that is sensitive to radiation at one or more specific wavelengths or is visually identifiable. Deposits of activated dopant on the outer surface of the insulator can be detected upon imaging of the outer surface of the insulator by appropriate imaging instruments or the naked eye. While this alerts one that there is moisture in the insulator, it does not address reducing or eliminating moisture in the insulator.

U.S. Pat. No. 5,847,325 discloses a composite electrical insulator suitable for high tension open air use wherein the insulator has an interior structural rod of an electrically insulating material and an outer coating formed of a thermoplastic material and having a plurality of radially extending sheds formed integrally therewith, the outer coating terminating adjacent the ends of the interior rod, the coating having at least two radially extending abutting surfaces formed to abut against mating abutting surfaces formed on an end fitting. The insulator provides good mechanical properties while being light weight and meeting all electrical requirements.

U.S. Pat. No. 5,877,453 discloses a composite insulator with a silicone rubber sheath coating the insulator rod between metal fittings. Adjacent the line fitting, at least, a series of weather sheds is mounted on the rod and fastened to the sheath with their hubs in abutting relationship and with one hub abutting the line fitting. Another series of sheds are spaced from each other and from the series of weathersheds having their hubs in abutting relationship. One objective of the technology is to reduce water droplet corona discharge and related aging or erosion, however it does not mitigate the problem.

Fangcheng Lü, Leilei Niu, Shenghui Wang, Tingyue Jiang, Wei Li, Jiayi Guo, Hao Li (First published: 19 Feb. 2021 https://doi.org/10.1049/iet-smt.2019.0558) disclose that a grading ring water droplet reduces corona discharge, but does not eliminate it. Further, it does not stop water droplets from forming on the insulator.

European Patent No. 0278606 discloses a high performance, high voltage electrical insulator, for use at greater than 15 kV in wet, contaminated conditions, is designed to give a minimum surface area while maintaining a low leakage current by specifying the ratios of shed diameter to shed pitch, leakage distance between support fittings to the straight line distance between support fittings, and the shed diameter to the support rod diameter. Through the use of specified silicone elastomeric compositions, or through the use of silicone compositions meeting specified electrical properties, an insulator meeting the design specifications is shown to be a useful high voltage insulator.

What is needed is a composite insulator, bushing or fuse cutout that is suitable for high rainfall and/or high humidity regions. It would be preferable if it was also suitable for high pollution regions. It would be preferable if it reduced algal adhesion and the resultant degradation of surface materials. It would be preferable if it was easy to manufacture.

### SUMMARY

The present technology is a composite insulator, bushing or fuse cutout that is suitable for high rainfall and/or high humidity regions. It is also suitable for high pollution regions. It is especially useful in coastal environments where fouling of insulators with bio-organisms is especially problematic. It is easy to manufacture with injection molding. The insulators of the present technology are used to reduce or eliminate algal growth, to reduce or eliminate retention of pollutants and to shed moisture.

In another embodiment, an insulator for use in power transmission and distribution is provided, the insulator comprising: a rod which includes an inner surface that defines a bore; a core rod which is housed in the bore; and a plurality of sheds which are continuous with the rod and extend outward therefrom, wherein at least one shed has a smaller diameter and at least one shed has a larger diameter and is disposed above the shed with the smaller diameter, the shed with the larger diameter including a downward extending perimeter lip.

In the insulator, there may be a series of sheds, the series of sheds alternating between the shed with the large diameter and the shed with the small diameter.

The insulator may further comprise a housing which sheaths the core rod.

In the insulator, the housing and the sheds may comprise silicone.

In the insulator, the core rod may comprise a fiberglass reinforced polymer.

The insulator may be a suspension insulator.

The insulator may be a line insulator.

The insulator may be a post insulator.

The insulator may be configured for use in a fuse cutout.

In the insulator, the core rod may be a conducting rod.

The insulator may further comprise an insulating layer in the bore between the core rod and the inner surface of the rod.

The insulator may be a bushing.

In the insulator, the rod and sheds may comprise a composite material.

In the insulator, the rod and sheds may be injection molded.

In one embodiment, a composite insulator is provided for use with distribution (under 69 kV) and transmission lines (Over 69 kV), the composite insulator comprising: a rod which includes a core rod and a housing which sheaths the core rod; and a plurality of sheds wherein at least one shed has a smaller diameter and at least one shed has a larger diameter and is disposed above the shed with the smaller diameter, the shed with the larger diameter including a perimeter lip.

In the composite insulator there may be a series of sheds, the series of sheds alternating between the shed with the large diameter and the shed with the small diameter.

In the composite insulator, the housing and the sheds may comprise silicone.

The composite insulator may be a suspension insulator, a line insulator or a post insulator.

In another embodiment a method of manufacturing a unit body for use in an insulator, the unit body comprising a rod and a series of sheds, at least one shed including a downward extending perimeter drip bead, the method comprising providing a mold; injecting a composite material into the mold; and releasing the rod and series of sheds from the mold.

In another embodiment, a method of reducing algal growth on a composite insulator is provided, the method comprising: selecting a composite insulator, the composite insulator comprising: a rod which includes a core rod and a housing which sheaths the core rod; and a plurality of sheds wherein at least one shed has a smaller diameter and at least one shed has a larger diameter and is disposed above the shed with the smaller diameter, the shed with the larger diameter including a perimeter lip; and attaching the composite insulator to both a transmission line and a transmission line support or a distribution line and a distribution line support.

In the method, the composite insulator may be substantially vertically disposed.

### FIGURES

FIG. 1 is a longitudinal sectional view of the composite distribution and transmission line, post or suspension insulator of the present technology.

FIG. 2 is a partial longitudinal sectional view of the composite insulator of FIG. 1.

FIG. 3 is a close up of the lip showing the various angles and radiuses.

FIG. 4 is a partial longitudinal sectional view of a fuse cutout.

FIG. 5 is a longitudinal sectional view of a bushing.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### Definitions

Bushing—in the context of the present technology, a bushing is an insulator with a conductor core rod.

Fuse cutout—in the context of the present technology, a fuse cutout is a fuse holder that includes at least one insulator.

Insulator—in the context of the present technology, an insulator includes a bushing, the insulator of a fuse cutout, distribution and transmission line insulators, post insulators and suspension insulators.

Drip bead—in the context of the present technology, a drip bead is found at the perimeter of a shed and is shaped to cause moisture to form droplets which are released from the drip bead, thus reducing or eliminating moisture and pollution issues with the insulator. The drip bead also functions as a rain guard.

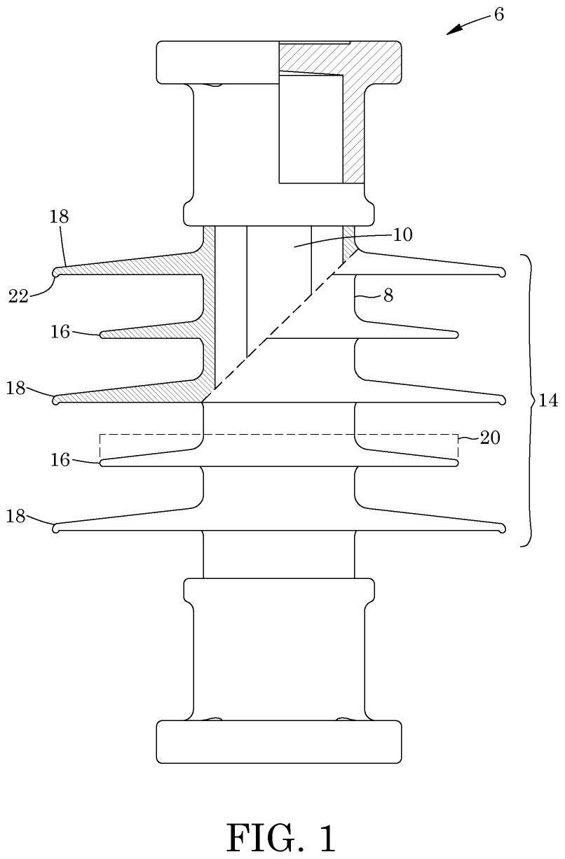

Downward—in the context of the present technology, downward is defined in relation to the upper surface and the lower surface of a shed, wherein the upper surface and the lower surface extend outward to the perimeter. The upper surface has a slope downward from the rod, as can be seen in FIG. 1.

### DETAILED DESCRIPTION

As shown in FIG. 1, a composite distribution and transmission line, post insulators or suspension insulator, generally referred to as 6 has a rod 8 with a bore 10 therethrough. Extending outward from the rod 8 is a series of sheds, collectively referred to as 14. The sheds 14 are continuous with the rod 8, in other words, the two are a unit body construction and may be injection molded. There are smaller diameter sheds 16 and larger diameter sheds 18. The larger diameter sheds 18 extend outward beyond the perimeter 20 of the smaller diameter sheds 16. The larger diameter sheds 18 terminate in a perimeter lip 22 which extends downward from the lower surface of the shed 18 (wherein the upper surface of the shed slopes downward from the rod 8). The perimeter lip 22 functions as a rain guard or drip bead that sheds water and pollution. This allows the hydrophobic property of the surface material to be minimally impacted. It also reduces or eliminates settlement of any protein or spray-borne algae that might encourage algae growth on the surface.

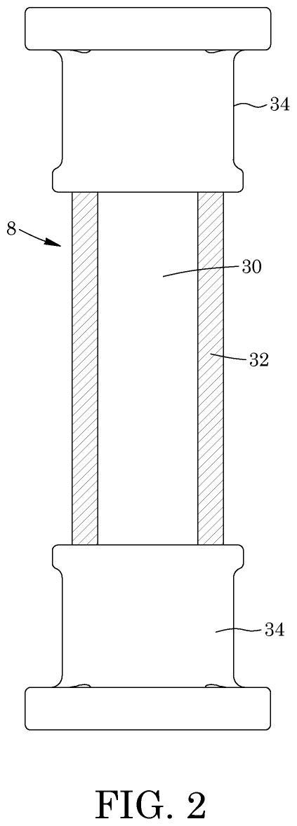

As shown in FIG. 2, the rod 8 includes a core rod 30, which is preferably fiberglass or fiberglass reinforced polymer, and a housing 32 which is preferably silicone rubber which sheaths the core rod 30. The sheds 14 are preferably silicone rubber. Each end has a fitting 34.

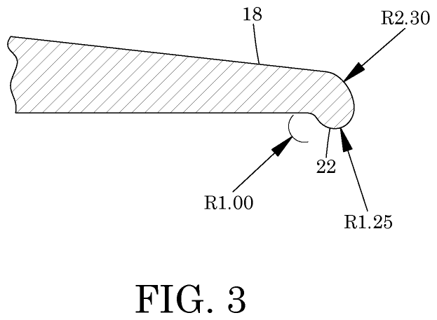

The details of the perimeter lip 22 are shown in FIG. 3.

In one embodiment, in use, the composite insulator 6 is attached to a distribution or transmission line (power line) support at one end and to the power line at the other end, with the orientation being essentially vertical for a line and post insulator, and essentially horizontal for a suspension insulator. The power line support may be a metal tower or wooden pole or a composite pole. The substantially vertical disposition allows the larger diameter sheds to direct one or more of the rain, seawater spray, lake water spray, salt solution from road deicing, pollution, nutrients and algae away from the smaller diameter sheds, while also reducing any flow to the underside of the larger diameter sheds with the perimeter lip.

In another embodiment, in use, the composite insulator 6 is attached to a distribution line support at one end and to the distribution line at the other end, with the orientation being essentially vertical. The distribution line support may be a metal, composite or wooden pole. The substantially vertical disposition allows the larger diameter sheds to direct one or more of the rain, seawater spray, lake water spray, salt solution from road deicing, pollution, nutrients and algae away from the smaller diameter sheds, while also reducing any flow to the underside of the larger diameter sheds with the perimeter lip. The composite insulator is preferably a suspension insulator.

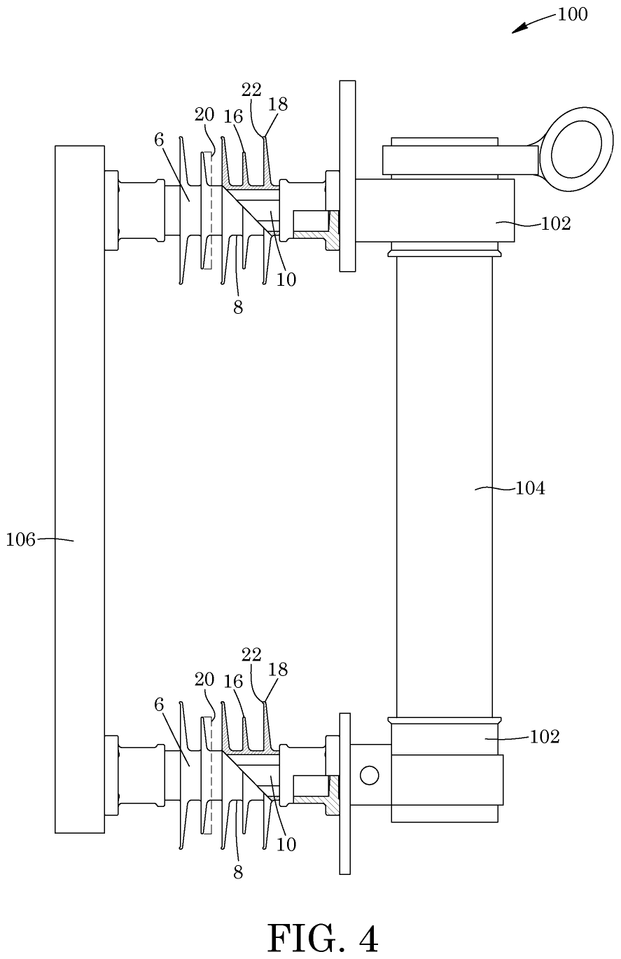

Another embodiment shown in FIG. 4, is a fuse cutout, generally referred to as 100. The fuse cutout 100 includes at least one insulator 6. The insulator 6 includes a rod 8, with a bore 10 therethrough. The fuse cutout 100 further includes a fuse holder 102, which contains a replaceable fuse 104, and a base 106. Extending outward from the rod 8 is a series of sheds 14 with one or more including a perimeter lip 22. There are smaller diameter sheds 16 and larger diameter sheds 18. The larger diameter sheds 18 extend outward beyond the perimeter 20 of the smaller diameter sheds 16. The larger diameter sheds 18 terminate in a perimeter lip 22. The details of the perimeter lip 22 are shown in FIG. 3. The perimeter lip 22 functions as a rain guard or drip bead that sheds water and pollution. This allows the hydrophobic property of the surface material to be minimally impacted. It also reduces or eliminates settlement of any protein or spray-borne algae that might encourage algae growth on the surface.

As shown in FIG. 2, the rod 8 includes a core rod 30, which is preferably fiberglass or a fiberglass reinforced polymer, and a housing 32 which is preferably silicone rubber which sheaths the core rod 30. The sheds 14 are preferably silicone rubber.

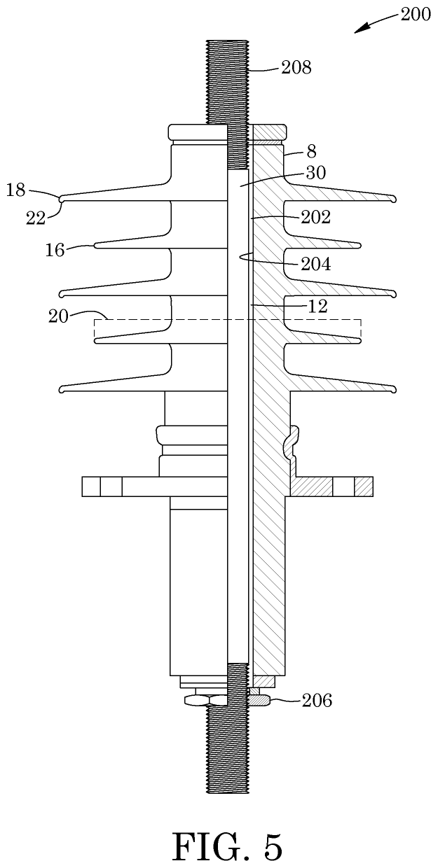

Another embodiment shown in FIG. 5 is a bushing, generally referred to as 200. The bushing 200 includes a rod 8 with a bore 12 therethrough and a core rod 30 which is a conductor. There is an insulating layer 202 in the bore 12 between the inner surface 204 of the rod 8 and the inner core rod 30. The insulating layer may be mineral oil, or curable epoxy resin. The bushing 200 further includes a gasket 206 at the transformer end and a terminal 208 at the end opposite the transformer end. Extending outward from the rod 8 is a series of sheds 14 with one or more including a perimeter lip 22. There are smaller diameter sheds 16 and larger diameter sheds 18. The larger diameter sheds 18 extend outward beyond the perimeter 20 of the smaller diameter sheds 16. The larger diameter sheds 18 terminate in a perimeter lip 22. The details of the perimeter lip 22 are shown in FIG. 3. The perimeter lip 22 functions as a rain guard or drip bead that sheds water and pollution. This allows the hydrophobic property of the surface material to be minimally impacted. It also reduces or eliminates settlement of any protein or spray-borne algae that might encourage algae growth on the surface.

In yet another embodiment, the rain guard or drip bead is shaped as a downward extending perimeter wedge.

In yet another embodiment, each smaller diameter shed 16 also have a rain guard or drip bead, whether as a lip or a wedge.

In yet another embodiment, the sheds are all the same diameter.

In yet another embodiment, all the sheds have a rain guard or drip bead.

To manufacture the rod and the series of sheds, wherein at least one shed has a downward extending perimeter drip bead, a mold of the rod and the series of sheds is provided. A composite material is injected into the mold and then the unit body rod and series of sheds is released from the mold.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. An insulator for use in power transmission and distribution, the insulator comprising: a rod which includes an inner surface that defines a bore; a core rod which is housed in the bore; and a plurality of sheds which are continuous with the rod and extend outward therefrom, wherein at least one shed has a smaller diameter and at least one shed has a larger diameter, the at least one shed with the larger diameter including a downward extending perimeter drip bead and the shed with the smaller diameter lacking the downward extending perimeter drip bead.

2. The insulator of claim 1, wherein there is a series of sheds, the series of sheds alternating between the shed with the large diameter and the shed with the small diameter.

3. The insulator of claim 2, wherein the downward extending perimeter drip bead is a lip.

4. The insulator of claim 3, where the downward extending perimeter drip bead is a wedge.

5. The insulator of claim 4, further comprising a housing which sheaths the core rod.

6. The insulator of claim 5, wherein the housing and the sheds comprise silicone.

7. The insulator of claim 5 wherein the core rod comprises a fiberglass reinforced polymer.

8. The insulator of claim 7, wherein the insulator is a suspension insulator.

9. The insulator of claim 7, wherein the insulator is a line insulator.

10. The insulator of claim 7, wherein the insulator is a post insulator.

11. The insulator of claim 7, wherein the insulator is configured for use in a fuse cutout.

12. The insulator of claim 1, wherein the core rod is a conducting rod.

13. The insulator of claim 11, further comprising an insulating layer in the bore between the core rod and the inner surface of the rod.

14. The insulator of claim 13 wherein the insulator is a bushing.

15. The insulator of claim 14, wherein the rod and sheds comprise a composite material.

16. The insulator of claim 15, wherein the rod and sheds are injection molded.

17. The insulator of claim 16, wherein the downward extending perimeter drip bead has an inner radius of 1.00, an upper radius of 2.30 and a lower radius of 1.25.

18. A method of manufacturing a unit body for use in an insulator, the unit body comprising a rod and a series of sheds, wherein at least one shed has a smaller diameter and at least one shed has a larger diameter and is disposed above the shed with the smaller diameter, the shed with the larger diameter including a perimeter drip bead and the shed with the smaller diameter lacking the perimeter drip bead, the method comprising providing a mold; injecting a composite material into the mold; and releasing the rod and series of sheds from the mold as a unit body.

19. A method of reducing algal growth on a composite insulator, the method comprising: selecting a composite insulator, the composite insulator comprising: a rod which includes a core rod and a housing which sheaths the core rod; and a plurality of sheds wherein at least one shed has a smaller diameter and at least one shed has a larger diameter and is disposed above the shed with the smaller diameter, the shed with the larger diameter including a perimeter drip bead and the shed with the smaller diameter lacking the perimeter drip bead; and attaching the composite insulator to both a transmission line and a transmission line support or a distribution line and a distribution line support.

20. (canceled)

21. The method of claim 18, wherein the downward extending perimeter drip bead has an inner radius of 1.00, an upper radius of 2.30 and a lower radius of 1.25.
